(19) United States
(12) Patent Application Publication
(10) Pub. No.: US 2003/0005409 A1
(43) Pub. Date: Jan. 2, 2003

(54) System and method for modifying software without halting its execution

(76) Inventor: Pradeep Tumati, Blacksburg, VA (US)

Correspondence Address: McNair Law Firm, P.A., P.O. Box 10827, Greenville, SC, 29603, US

(21) Appl. No.: 10/067,831

(22) Filed: Feb. 5, 2002

Related U.S. Application Data
(60) Provisional application No. 60/302,420, filed on Jul. 2, 2001.

(51) Int. Cl. G06F 9/44

(52) U.S. Cl. 717/110

(57) ABSTRACT

This invention is directed to a computerized system and method for modifying an executing target software application segmented into grains according to a hot pack without halting its execution. Modification can be performed according to second version object code contained within said hot pack. Modifications can be performed immediately upon receipt of the hot pack or during the subsequent resumption of execution of the target application.

### FIELD OF THE INVENTION

This invention is directed to a computerized system and method for modifying an executing target computer application without the need to halt the target application. This application claims priority pursuant to 35 U.S.C. §119 of provisional patent application No. 60/302,420 that was filed on Jul. 2, 2001.

### BACKGROUND OF THE INVENTION

From the mid-1980's to the present, there has been an extraordinary adaptation of computers into almost all aspects of business. The unparalleled explosion of the computer software industry and the Internet has led to a high reliance on technology and particularly, software applications. While there have been astronomical advances in computer hardware, essentially it is the software applications which are at the core of the functionality of computers. Simply said, a computer is useless without software to run it. Nearly a decade ago, e-mail was just entering the private sector and becoming adopted by businesses for day to day communications. Today, it is hard to imagine functioning without such advances as e-mail, instant messaging, global communications, file transfers, and other electronic transmissions all made possible by advances in computer technology. The side effect of this tremendous acceptance of computerized systems is that individuals and businesses are becoming more and more reliant upon these systems and, particularly, on the applications running them. It has now reached the point to where applications need to run uninterrupted or else their users are deprived of their functionality and operations of the business are dramatically effected

Applications that must run uninterrupted exist in several areas. For example, business software that provides service for clients 24 hours a day, such as 24-hour stock trading systems, hospital equipment used to maintain patients' health, and radar and air traffic control systems which are used to control airline flights. None of these systems can tolerate downtime.

In the case of stock trading, seconds of downtime in today's volatile stock market can cost millions of dollars. Banking software and many e-businesses need their software running continuously. A period of downtime damages both the profits of a company and the goodwill a company has developed by offering continuous service.

In today's global economy, there is no time that a section of business software can be safely offline. Although it may be 3:00 a.m. in the United States and 9:00 a.m. in London, potential as well as existing customers need to access computer systems at all times. Thus, there is no time that is conducive to having a software outage.

With the necessity of software applications running 24-hours a day and seven days a week, a problem is created as to how to update or maintain the software of the system. Software development is complicated and can involve millions of lines of code which, inevitably, will need to be updated many times throughout its life-span. Modifications are necessary for both bug correction and to offer new functionality. To compound the problem, it is common practice for a software vendor to issue software with known bugs that are to be corrected later. The “first-in-market” strategy has created the practice of distributing “beta” versions and 1.0 versions. This strategy does not allow a software vendor to absolutely perfect the software product before going to market. With the existing technology, software must be halted before an upgrade can be made. Thus, businesses have to choose between downtime that results in lost customers and profits or upgrading software to offer new functionality or correct bugs.

While profits and customer relations are affected, more important are health care concerns. Today's new hospital equipment is mostly computerized and contains software. Therefore, hospitals have to wait for a piece of equipment to no longer be in use before upgrading the residing application. For example, problems arise when a patient is in critical need of a piece of equipment and that equipment needs to be upgraded for the benefit of the patient but the equipment simply can not be turned off. In this situation, the patient is not able to receive the best possible care do to the lack of the existence of software as a catch-22 exists between operating with outdated software or stopping the software for an upgrade. Attempts in the past to solve this problem have resulted in maintaining redundant systems which at least doubles the cost of the system to the hospital. While redundant systems are a good practice, they require disconnecting a patient from a piece of equipment, replacing the existing equipment with a new piece of equipment, and performing maintenance on the existing piece of equipment. The ability to update the software without needing to halt the use of the equipment would significantly reduce the number of redundant systems needed and would allow a back-up piece of equipment to service several online systems.

Also of importance are the computer systems used by air traffic controllers and military radar systems. Both of these systems need to run uninterrupted, yet both need to be periodically upgraded.

Previous attempts to provide for the modification of an executing application have not provided a satisfactory remedy. Previous attempts fall short in at least three key areas. First, they create another application in memory that wastes valuable computer resources. Second, if the old application takes a long time to finish operating, then there will be two applications in memory wastefully using resources for an unacceptably long time or perhaps indefinitely. Third, system failures during the modification process severely damage the integrity of the computer system.

For example, U.S. Pat. No. 4,954,941 attempts to provide a method for modifying a currently executing application. It allows an executing application to be modified so long as errors in data are acceptable. Otherwise, the system halts the executing application and performs the modification. This system is only a usable solution if data corruption is acceptable.

Another example is U.S. Pat. No. 5,274,808, which attempts to alleviate the data integrity concerns of the U.S. Pat. No. 4,954,941 patent by creating a separate modified application that runs with the other unmodified application. Data is directed to the new application while the data in the old application ends its execution. When the old application finishes, the new, modified application becomes the only version of the application. This process, however, wastes valuable computer resources.

Accordingly, an object of the present invention is to provide a method to safely modify an executing software application without halting the application.

Another object of the present invention is to provide software that will maintain a currently executing application without having to halt the application and while maintaining data integrity.

Another object of the present invention is to provide software that can update an executing application in RAM and store the updated application to fixed storage medium simultaneously.

Still another objective of the present invention is to provide a system and method for modifying software that does not have a steep learning curve.

### SUMMARY OF THE INVENTION

The above objectives are accomplished through an automated system and method for modifying an executing software application, having an address space and at least one grain, defined by grain boundaries, and crumb associated with at least one grain, without halting the executing application comprising a computer readable medium and a set of computer readable hot swapper instructions. A computerized system and embodied in a computer readable medium is provided having a set of computer readable instructions embodied in the computer readable medium. A method for performing the above functionality is also provided since these steps can be automatically performed through computer software or manually performed through human intervention. The computer readable instructions provide for receiving a hot pack having a dictum and a second version grain, opening the hot pack, suspending the target software application, determining the status of at least one of the first version grains of the target software application, modifying at least one of the first version grains of the target software application according to the second version grain and the dictum of the hot pack if the determination of the status of the first version grain allows for its immediate modification, and, resuming execution of the target application so that modification of the target software application is achieved without halting its execution. Additionally, performance of a validity operation according to the dictum can be triggered so that data and functional integrity is maintained within the target software application subsequent modification of the target software application.

Further, the system can include instructions for resizing the address space of the target software application according to the hot pack, copying the second version grain within the address space of the target software application, and copying the dictum into the address space of the target software application.

The first version grains can have associated crumbs having an active and inactive state and the computer readable instructions include instructions for activating the associated crumb upon the determination that the status of the first grain to be modified does not allow for its immediate modification. The system can also include instructions for, when encountering the crumb in an active state, suspending the executing software application, determining whether the first grain associated with the active crumb can be modified according to the associated dictum, modifying the first version grain according to the second version grain and the dictum if the determination of whether the first version grain can be modified is affirmative, and resuming execution of the target software application so that the target application can be modified without halting its execution. The system can also include instructions for determining if any dictums associated with active crumbs can be executed upon encountering any active grain and execute all dictums that are properly executable.

The system can include a hot pack contained with the computer readable medium, a second version grain contained within the hot pack, and a dictum associated with at least one of the first version grains contained within the hot pack for providing instructions for modification of at least one of the first version grains according to the dictum.

### DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a schematic of the hardware and software;

FIG. 2 is a schematic of grains and grain boundaries;

FIG. 3 is a schematic illustrating the modification of an old grain;

FIG. 4 is a flowchart illustrating the hot swapper; and, FIG. 5 is a flowchart illustrating the steps for a crumb.

### DESCRIPTION OF A PREFERRED EMBODIMENT

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated. An object or module is a section of computer readable code embodied in a computer readable medium that is designed to perform a specific task or tasks. Actual computer or executable code or computer readable code may not be contained within one file or one storage medium but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such as the instructions stored in a computer readable medium that produce an article of manufacture including instruction means that implement the functions specified in the flowchart block or blocks. Computer program instructions may also be loaded onto a computer or other programmable apparatus to produce a computer executed process. These instructions are executed on the computer or other programmable apparatus which provide steps for implementing the functions specified in the flowchart block or blocks. Accordingly, elements of the flowchart support combinations of means for performing these special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention.

For purposes of explaining this invention to those skilled in the art, the following terminology is used.

“Initial Version”—The alpha version of source code, or object code. This version is created without the existence of any previous versions and is the version that exists before all others.

“First Version”—A version prior to a subsequent version. The first version can also be the initial version, but is not necessarily the initial version. For example, version 2.0 can be a first version to version 3.0. A first version is modified to a second version as described in this application.

“Second Version”—A version subsequent to a first version which is a modification of the first version. The second version would, for example, be version 3.0 from 2.0.

“Source code” is program instructions generally written as a text file that must be translated by a compiler or interpreter or sent into object code for a particular computer before the computer can execute the program.

“Object code” is computer readable output produced by compiler, interpreter, or assembler that can be executed directly by a computer.

“Executable code” is a collection of object code that may be linked with libraries in order to produce a finalized program to be executed by a computer.

“Halting”, when used in terms of target application execution, means when the target application is stopped and the instruction counter is reset to the initial position. Therefore the execution of the application begins from the beginning rather than resuming from where the instruction counter is located.

“Suspension”, when used in terms of target application execution, means when execution of the target application is suspended without altering the position of the instruction counter. Therefore, the target application can be resumed from where the instruction counter is located rather than resetting the instruction counter to the initial position.

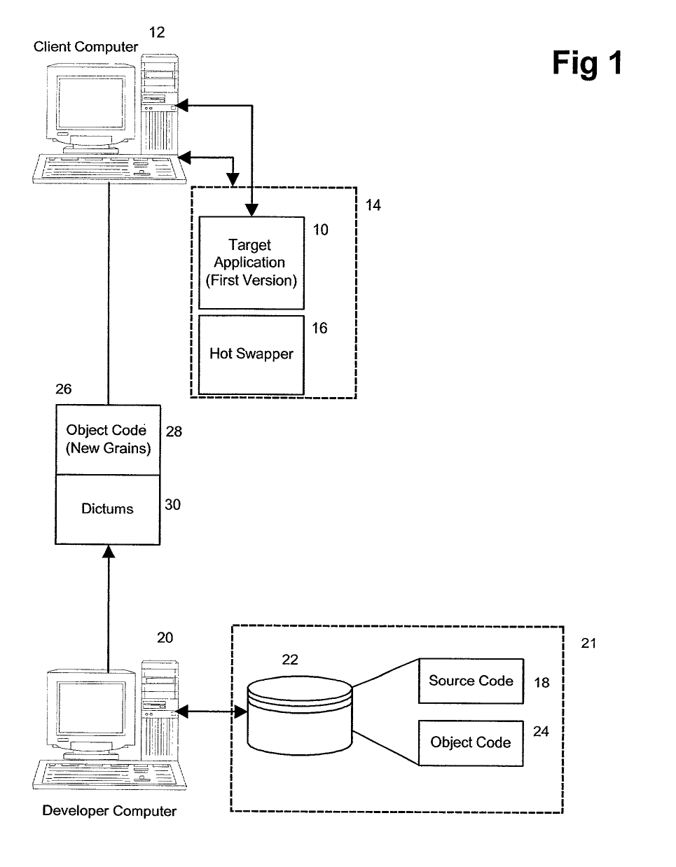

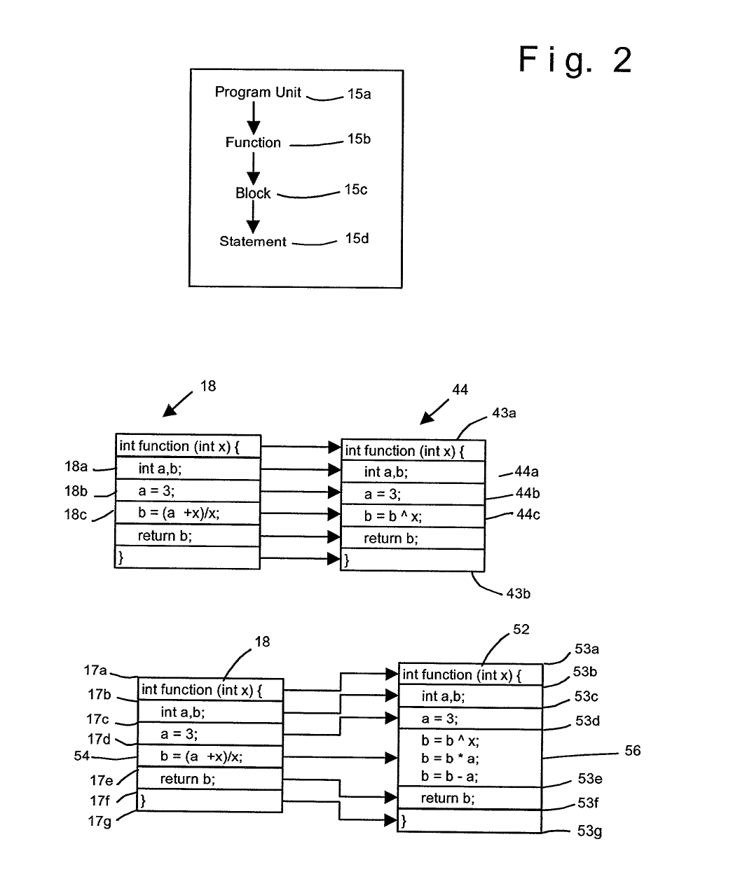

In development of software, there are two stages. First, the initial version is created by the computer programmer and shipped to a customer for execution. After this version is executing at the client's location, the initial version may need to be modified for various reasons. Such reason can be to add functionality, correct errors, or to provide compatibility with new or different hardware. When the first version is created, the source code and associated object code is stored in the database 22 of FIG. 1 of the developer computer 20 within a computer readable medium 21. The computer programmer uses a computer program such as an editor to create human readable source code representing the desired functionality according to the programmer's wishes. The source code is then translated into object code through a compiler, translator, or assembler. The object code is then sent to a customer or client site for execution.

Subsequently, the computer programmer may modify the first version to create a second version. The second version is present at the computer programmer's location. Therefore, the client or customer computers that have the initial version executing need to be updated so as to be executing the second version rather than the outdated initial version. For purposes of this invention, the initial version is also a first version, but a first version does not have to be the initial version.

Referring to FIG. 1, a client computer 12 contains a readable medium 14 that has a first version of object code 10, also described as the target application, executing on computer 12. While object code can be linked to libraries to create executable versions, the term object code is used to include the executable version of the software. The target application is contained within computer readable medium 14. Additionally, computer readable instructions, coined a “hot swapper,” is present in computer readable medium 14 of client computer 12. Hot swapper 16 is a set of computer readable instructions that performs the functionality of modifying the first version to the second version on client computer 12 without halting target application 10. Hot swapper 12 may be a separate application from the target application and therefore can run continuously on the client computer regardless of whether the target application is executing or not. The hot swapper may also be functionality embedded within target program 10 and contained within the same object code as the target. If the hot swapper is part of the target program, then it automatically executes whenever the target program executes.

When the computer programmer wishes to update a first version to a second version, the computer programmer utilizes a development computer 20 that contains a development environment for updating the software. The computer programmer retrieves source code 18 into an editor and performs the edits necessary to convert the first version of the source code to the second version. Once the source code is completed, object code 24 is created from source code 18. The information necessary to modify the first version to the second version is then stored in a computer file 26, coined as a “hot pack,” that is then transmitted from the developer computer to the client computer. The hot pack contains at least a portion of object code 28 of the second version to be used to modify the first version. The portion of object code contained in the hot pack can be called second version grains further define below. Rules or dictums 30 for performing the modification of the first version to the second version are also included in the hot pack. Dictums are instructions that contain the actual steps and conditions necessary to replace the first version object code with second version object code. There are at least three types of dictums, first for modification of a first version to a second version, second for performing certain tasks based upon the condition of the target application, and third, dictums that both modify portions of object code or grains as well as perform certain tasks associated with that dictum. For example, dictums may inform the hot swapper to replace certain portions of object code or grains only upon predetermined conditions such as the state of the instruction counter, the value of certain variables, or the ability to execute several dictums at once. Therefore, the hot pack contains not only what to use for modifying the first version, but also how to perform the modifications.

When the hot pack is sent to the client so that the first version executing on the client's computer can be updated. The hot pack is then received by hot swapper 16 of client computer 12 and the hot pack is then opened in order to perform the necessary modifications on the target application. The object code of the target application is replaced with a second version object code 28 of the hot pack. Turning now to FIG. 2, a first (old) function 18 is shown having grain boundaries defining grains 18a, 18b, and 18c. Grains delineate the source code and object code into discreet segments of specific statements 15d, functions 15b, or the entire program unit 15a. By dividing the source code into discreet segments, it is possible to map the grains of the first version to the grains of the second version thereby localizing the amount of changes needed to the target application to modify a first version to a second version. By modifying only those grains affected, an efficient method of updating a first version to a second version is achieved.

By way of example, first grain 18 is contained within a first version or initial version of the target software application executing on the client that the programmer wishes to modify. The computer programmer retrieves the source code containing function 18 into an editing module and modifies grain 18c into grain 44, thereby, creating function 44. In this example, grain 18c of function 18 contains the equation (a+x)/x. This equation needs to be updated to bˆ x, shown as 44c of function 44. First (old) grain 18c is replaced with the second (new) grain 44c in order to update the first version to the second version. A dictum or rule would be associated with the modification of grain 18c to perform the steps to modify this grain and replace grain 18c with grain 44c. Additionally, the dictum may also contain other conditions to modify the grain. For example, the dictums associated with replacement of first grain 18c with second grain 44c may include a condition that grain 18a must be replaced with grain 44a contemporaneously. In this case, the dictum would not allow the modification of first grain 18c unless modification of grain 18a was also allowed. If grain 18a is not modifiable, grain 18c would not be modified and must be marked for subsequent modification when conditions for modification contained in the dictum are satisfied. When the first version grain is immediately modifiable upon initial execution of the hot pack, the first version grain can be modified in an instantaneous phase as explained below. When the first version grain cannot be modified immediately based upon some condition unsatisfied, the modification must take place during an incremental phase as explained below.

Execution of dictums contained in the hot pack for replacing old grains with new grains can occur in two manners. In an instantaneous phase, the hot swapper has determined that there are dictums that can be executed immediately. The instantaneous phase occurs during the period of time when the target application is first suspended and when the execution of the target application is first resumed. These dictums are executed and the second (new) grains associated with these dictums are used to modify the corresponding first (old) grains of the executing application according to the dictums executed. The address space of the first grain that is now not being used can then be placed in a garbage table for reuse. The garbage table is an area or table that tracks address space within the target application that is no longer in use and can be recaptured or reused for other purposes.

In the instantaneous phase, the first grain is immediately modified according to the dictums associated with the first grain according to the hot pack. The hot swapper suspends the execution of the target application and then examines the address space of the application. If necessary, the hot swapper resizes the address space of the target application and executes all the dictums that can be immediately executed. The hot swapper then resumes the execution of the target application. If a dictum can not be immediately modified, the modification of those grains is delayed for modification during the incremental phase.

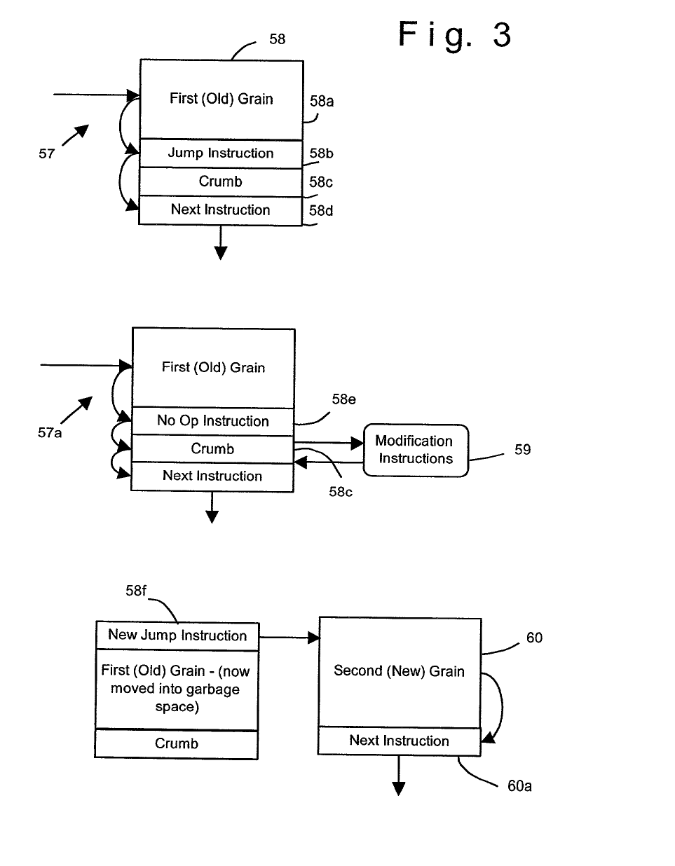

Referring to FIG. 3, modification of the first grain can be achieved by adding a new jump instruction 58f so as to proceed to first (old) grain 58. Second (new) grain 60, having been copied to the resized address space of the target application, can be the subject of new jump instruction 58f. Therefore, when the target application resumes, jump instruction 58f causes second grain 60 to execute rather than first grain 58a. The first version is modified to the second version.

The incremental phase, occurs after the first resumption of the target application and uses a crumb to indicate what dictums need to be executed after the instantaneous phase. Adjacent to a first grain is a jump instruction 58b and crumb 58c. The crumb and jump instruction can be added to the first grain by the hot swapper or can be associated with the first grain when the target application is compiled, assembled or translated. When the crumb is added by the hot swapper, jump instruction 58b is not necessary.

In alternative embodiments, one skilled in the art may use various means for establishing that a crumb has an active state and inactive state as well as various means for detecting the particular state of a crumb. An active crumb is one that will execute to cause to have executed modification instructions. Modification instructions are those instructions that perform the modification of the first version and can include dictums. Therefore, when the instruction counter encounters active grains, the target application may be modified according to the dictums that can be exeucted. An inactive grain does not cause the modification instructions to execute when encountered by the instruction counter.

In another embodiment, the crumbs can be activated when the hot pack is activated when the hot pack Is received or by the hot swapper at predetermined times. When all crumbs are active, the target application determines if any dictum is to be executed when any active crumb is encountered. Therefore, the target application is always checking to determine if dictums of a hot pack can be executed. However, this embodiment may cause unnecessary processing cycles to be used since all crumbs are active and all dictums are checked at all active crumbs.

In another embodiment, the next instruction command 58d is executed when jump instruction 58b passes control to next instruction command 58d that in turn passes control to the next grain. However, when the first version grain is to be modified in the incremental phase, the computer readable instructions, or hot swapper located at the client site, include instructions to convert jump instruction 58b into a no-op instruction 58e. The no-op instructions causes crumb 58c to execute thereby causing modification instructions 59 to execute. The modification instructions include instructions to perform the steps contained within the dictums as well as other functionality such as a validity operation. These modifications instructions can assist in the execution of dictums, merely cause the dictums to be executed, or insure that the dictums executed do not create invalid conditions within the target application through validity operations. A validity operation is a set of computer readable instructions associated with a dictum to insure data and functional integrity within the target application after modification. The validity operation can also contain instructions for internal processing, library calls, and input/output operations. For example, if grain 18b (FIG. 2) was to be modified to the statement a=5, the value stored in a grain 18c would have to changed in some cases to maintain data integrity. This is especially true if the instruction counter had already passed by grain 18b. Therefore, a validity operator could be used to change the value of “a” and data integrity is maintained. If the modification instructions determine that the first grain can be modified when the active crumb is encountered, new jump instruction 58f is placed in front of the first grain to point to new grain 60. New grain 60 then executes next instruction 60a. The old grain and associated old crumb are moved into the garbage table and no longer part of the executing code of the target application. Consequently, the functionality of new grain 60 effectively replaces the functionality of old grain 58 and the object code is updated to a second version. In placing second grain 60 and next instruction 60a within the address space of the target application, it may be necessary to resize the address space of the target application. Accordingly, the address space of the target application can be resized during the instantaneous phase or during the incremental phase to allow for such modification. Also, second grain 60 and next instruction 60a can be copied to the address space of the target application during the instantaneous phase or the incremental phase.

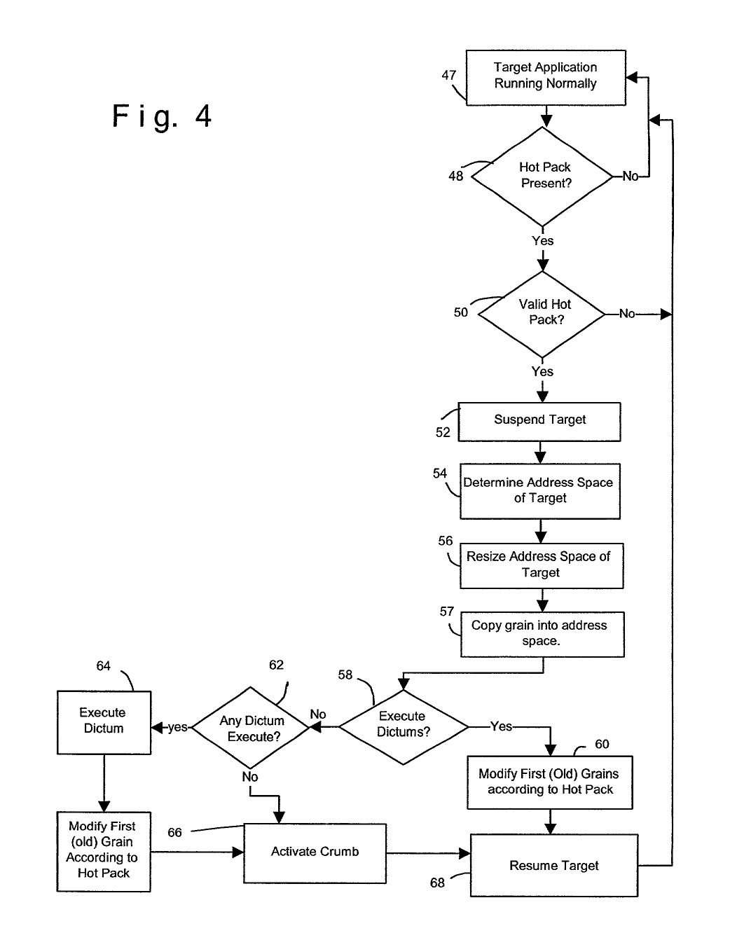

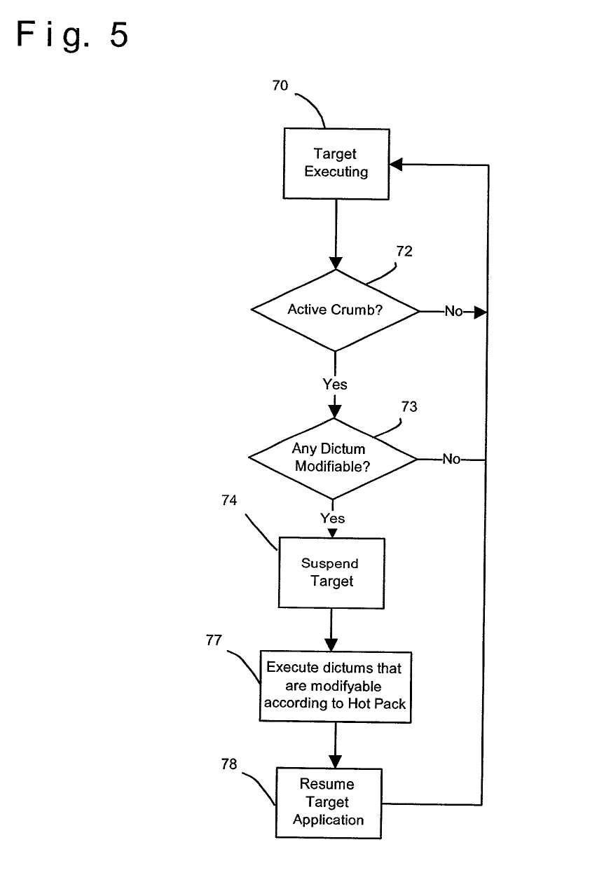

Referring now to FIG. 4, the steps for performing the modification of a first version to a second version are shown in more detail. Step 47 represents the executing application target object code executing. Step 48 represents the determination of whether a hot pack is present. If there is no hot pack present, the process returns to step 47 where the target application continues to execute. If a hot pack is present, a determination is made as to the hot pack's validity at step 50. A hot pack may be considered invalid if it has modifications that have already been completed, if it refers to a later version of the program then the one currently executing on the client computer or if the hot pack contains errors. If the hot pack is invalid, an error is generated and the system returns to step 47. If the hot pack is valid, the hot swapper suspends the target application in step 52. It is noted that the application is not halted since the application can be resumed from the existing location of the instruction counter and the instruction counter does not return to the initial setting. The hot swapper reads the address space of the program in step 54 in order to determine how much address space the new grains will need in order to be stored. The hot swapper then resizes the address space of the target application in step 56 in order to have enough space for the modifications according to the hot pack. It is possible that in determining the new address space, there may be space contained in the object code of the target that is not being used.

Next, the new grains can be copied into the expanded address space at step 57. Thus, the target application would contain the old and new grains within its address space. The second grain, if the first grain is immediately modifiable, can be copied into the address space of the first grain, if space is permitting. If space is not permitting, the second grain can be copied into another location apart from the first grain and a pointer placed in the location of the first grain to execute the second gain when the instruction counter reaches the location of the previous first grain. If a first grain cannot be immediately modified, the second grain is copied to a different part of the address space rather than simply overwriting the first grain and the crumb of the first grain is activated. The coping of the second grain can occur at any time after suspension of the target application and can be performed by the hot swapper or modification instructions. Once the second grains are located within the address space of the target application, the determination of which dictums are executable is made at step 58. Those dictums that are immediately executable are executed at step 60 and first grains are modified into second grains. Afterwards, the process is left to resume execution so that the first grain can be modified in the incremental phase. It is understood that crumbs can be added to grains when the source code is compiled or translated, when the hot pack is initially executed, or when the hot swapper executes.

The hot swapper then resumes the program in step 68 and returns to step 47 where the target application continues to execute. If all of the dictums in step 58 cannot be immediately executed, then step 62 determines if any dictum can be executed. If some dictums can be executed, then the first grain associated with that dictum is modified so that the second grain executes. After the immediate dictums are executed, the crumbs are activated for the grains that cannot be immediately modified in step 66 so that these grains may be modified in the incremental phase. If none of the dictums can be executed in step 62, then all of the first version grains have their crumbs activated in step 66. After step 66, the now updated program is resumed in step 68, and the program continues to run normally in step 47.

Alternatively, the hot swapper can check to see if all the dictums can be executed in step 58. If so, the hot swapper copies all the second grains in the hot pack into the address space and modifies the first grains to the second grains. The hot swapper then resumes the program in step 68 and returns to step 47 where the target application continues to execute. If all of the dictums in step 58 cannot be immediately executed, the determination is made as to whether any dictums can be executed. If some of the dictums can be executed, then the first grains associated with that dictum is modified so that the first grain is modified to the second grain. After these dictums are executed, the crumbs are activated for the grains associated with dictums that cannot be immediately modified so that these grains may be modified in the incremental phase. If none of the dictums can be executed, then all first grains have their crumbs activated and the target application is resumed.

In alternate embodiment, there may not be an instantaneous phase and every modification is handled through an incremental phase. In this embodiment, the first version grain crumbs can always be active and the dictums that can be executed are executed when any active grain is encountered. In the event that there are no dictums to execute the hot swapper would still determining this upon encountering the active grains.

FIG. 5 illustrates the steps taken when an active crumb is encountered when the target application is resumed as during the incremental phase. Crumbs are associated with at least one dictum. In step 70, the target program is executing after being resumed from the instantaneous phase. In step 72, the hot swapper determines if there is an active crumb. For example, if the instruction counter of the target application encounters an active crumb, then the modification instructions 59 (FIG. 3) are executed. If so, the hot swapper or the modification instructions attempts to update the corresponding grain when the modification instructions are included with the hot swapper. The update can be performed by the hot swapper instructions or computer readable instruction of the crumb itself. The modification instructions or hot swapper can either attempt to execute all dictums associated with all active crumbs or merely attempt to execute the dictums associated with the particular active crumb encountered.

If modification is not possible at step 73, than the target application continues execution and returns to step 70. The modification may not be necessary if some condition of the dictum associated the first grain or active crumb is not satisfied, or for other conditions preventing modification such as recursion. If a dictum is executable when an active crumb is encountered, the target application is suspended at step 74. It should be noted that certain conditions allow the active crumb's grain to be modified without having to suspend the target application. Additionally, the modification instructions executed by the active crumb's grain may also modify more than just that grain. The grains associated with the dictums executable are modified according to the associated dictum at step 77 and execution of the target application is then resumed at step 78. If no active crumb is encountered, the program continues to run normally in step 70. Once a grain is modified, the now deactivated crumb may be deleted from the address space of the target and the address space resized accordingly. A jump statement can be reinserted before the encountered crumb so that it is no longer an active crumb. Those skilled in the art will understand that there are various means and methods for activating and deactivating crumbs. The program then returns to a state of execution in step 70. Once a grain is modified, the now deactivated crumb may be deleted from the address space of the target and the address space resized accordingly. A jump statement can be reinserted before the encountered crumbs to that it is no longer an active crumb. Those skilled in the art, will understand that there are various means and methods for activating and deactivating crumbs. The program then returns to a state of execution in step 70.

While a preferred embodiment of the invention has been described using specific terms, such description is for illustrative purposes only, and it is to be understood that changes and variations may be made without departing from the spirit or scope of the following claims.

What is claimed is:

1. A computerized system embodied in a computer readable medium for modifying a target software application segmented into first version grains, comprising:
a set of computer readable instructions embodied in said computer readable medium for:
receiving a hot pack having a dictum and a second version grain associated with at least one of said first version grains,
opening said hot pack,
suspending said target software application,
determining the status of said dictum,
modifying at least one of said first version grains of said target software application according to said second version grain and said dictum of said hot pack if said determination of said status of said dictum allows for its immediate modification, and,
resuming execution of said target application so that modification of said target software application is achieved without halting its execution.

2. The system of claim 1 wherein said computer readable instructions include instructions for triggering performance of a validity operation according to said dictum so that data and functional integrity is maintained within said target software application subsequent modification of said target software application.

3. The system of claim 1 wherein said computer readable instructions include instructions for:
resizing the address space of said target software application according to said hot pack, and,
copying said second version grain within said address space of said target software application.

4. The system of claim 1 wherein said computer readable instructions include instructions for:
resizing the address space of said target software application according to said hot pack; and,
copying said dictum into said address space of said target software application.

5. The system of claim 1 wherein:
at least one crumb associated with at least one of said first version grains having an active and inactive state; and,
said computer readable instructions include instructions for activating said associated crumbs upon the determination that said status of said dictum associated with said first version grain does not allow for its immediate execution.

6. The system of claim 5 wherein said computer readable instructions include instructions for, when encountering said crumb in an active state:
suspending said executing software application;
determining whether said dictum associated with said active crumb can be executed;
modifying said first version grain according to said second version grain and said dictum if said determination of whether said dictum can be executed is affirmative, and,
resuming execution of said target software application so that said target application is modified without halting its execution.

7. The system of claim 6 wherein said computer readable instructions include instruction for adding at least one crumb to at least one of said first version grains that are to be modified according to said hot pack.

8. A computerized system embodied within a computer readable medium for modification of an executing target software application, having first version grains, comprising:
a hot pack contained within said computer readable medium;
a second version grain contained within said hot pack;
a dictum associated with at least one of said first version grains contained within said hot pack for providing instructions for modification of at least one of said first version grains according to said dictum and said second version grain;
a set of computer readable instructions embodied within said computer readable medium for:
suspending said target software application,
modifying at least one of said first version grains according to said second version grain and said dictum, and,
resuming execution of said target software application so that said target software application is modified without halting its execution.

9. The system of claim 8 wherein said computer readable instructions include instructions for triggering performance of a validity operation according to said dictum so that data and functional integrity is maintained within said target software application subsequent to modification of said target software application.

10. The system of claim 8 wherein said computer readable instructions include instructions for:
resizing the address space of said target software application according to said hot pack; and,
copying said second version grain to within said resized address space of said target software application.

11. The system of claim 8 wherein said computer readable instructions Include instructions for:
resizing the address space if said target software application according to said hot pack; and,
copying said dictum into said address space of said target application.

12. The system of claim 8 wherein:
at least one crumb associated with at least one of said first version grains having an active and inactive state; and,
said computer readable instructions include instructions for activating said crumb upon the determination that said status of said dictum associated with said first grain to be modified does not allow for its immediate modification.

13. The system of claim 12 wherein said computer readable instructions include instructions for when encountering said crumb in said active state:
suspending said executing software application;
determining whether said dictum in turn associated with said first grain associated with said active crumb can be modified;
modifying said first version grain according to said second version grain and said dictum if said determination of whether said first version grain can be modified is affirmative; and,
resuming execution of said target software application so that said target application can be modified without halting its execution.

14. A computerized system embodied within a computer readable medium for modification of an executing target software application having first version grains comprising:
a hot pack contained within said computer readable medium;
a second version grain contained within said hot pack;
a dictum associated with at least one of said first version grains contained within said hot pack for providing instructions for modification of at least one of said first version grains according to said dictum;
a means for suspending said target software application;
a means for modifying at least one of said first version grains according to said second version grain and said dictum; and,
a means for resuming execution of said target software application so that said target software application is modified without halting its execution.

15. The system of claim 14 including a means for preforming a validity operation according to said dictum so that data and functional integrity is maintained within said target software application subsequent modification of said target software application.

16. The system of claim 14 including:
a means for resizing said target application's address space according to said hot pack; and,
a means for copying said second version grain to within said resized address space of said target software application.

17. The system of claim 16 including a means for copying said dictum into said address space of said target application.

18. The system of claim 14 including:
at least one crumb associated with at least one of said first version grains having an active and inactive state;
a means for determining whether said dictum associated with at least one of said first version grains can be activated;
a means for activating said crumb upon the determination that said status of said dictumdoes not allow for its immediate modification.

19. The system of claim 18 including:
a means for determining whether active crumb is encountered;
a means for suspending said executing software application upon encountering said active crumb;
a means for determining whether said dictum associated with said active crumb can be modified according to said dictum;
a means for modifying said first version grain according to said second version grain and said dictum if said determination of whether said dictum can be executed is affirmative; and,
a means for resuming execution of said target software application so that said target application can be modified without halting its execution.

20. A method for modifying a target software application segmented into first version grains with each of the first version grains having associated crumbs with the associated crumbs having an active and inactive state, comprising the steps of:
providing a hot pack having a dictum and a second version grain,
suspending said target software application,
determining the status of said dictum;
modifying at least one of said first version grains of said target software application according to said second version grain and said dictum of said hot pack if said determination of said status of said dictum allows for its immediate modification, and,
resuming execution of said target application so that modification of said target software application is achieved without halting its execution.

21. The system of claim 20 including the steps of performing a validity operation associated with said dictum so that data and functional integrity is maintained within said target software application subsequent modification of said target software application.

22. The system of claim 20 including the steps of:
resizing the address space of said target software application according to said hot pack; and,
copying said second version grain within said address space of said target software application.

23. The system of claim 20 including the steps of:
Resizing the address space of said target software application according to said hot pack; and,
copying said dictum into said address space of said target software application.

24. The system of claim 20 including the steps of:
providing at least one crumb associated with at lest one of said first version grains having an active and inactive state; and,
activating said crumb upon the determination that said dictum associated with at least one of said first version grains does not allow for its immediate execution.

25. The system of claim 24 including upon resumption of execution:
suspending said executing software application;
determining whether said dictum associated with said first version grain can be modified upon encountering said active grain;
modifying said first version grain according to said second version grain and said dictum if said determination of whether said dictum can be executed is affirmative; and,
resuming execution of said target software application so that said target application can be modified without halting its execution.

26. A computerized system embodied in a computer readable medium for modifying a target software application segmented into first version grains having associated crumbs, comprising:
a set of computer readable instructions embodied in said computer readable medium for:
receiving a hot pack having a plurality of dictums and plurality of second version grains encountered with said first version grains,
opening said hot pack,
suspending said target software application,
determining the status of said plurality of dictums to discover whether any of said dictums can be immediately executed,
modifying said first version grain associated with said dictum that can be immediately executed, and,
resuming execution of said target application so that modification of said target software application is achieved without halting its execution.

27. The system of claim 26 wherein said computer readable instructions include instructions for triggering performance of a validity operation according to said dictums so that data and functional integrity is maintained within said target software application subsequent modification of said target software application.

28. The system of claim 26 wherein said computer readable instructions include instructions for:
resizing the address space of said target software application according to said hot pack, and,
copying said second version grains within said address space of said target software application.

29. The system of claim 26 wherein said computer readable instructions include instructions for:
resizing the address space of said target software application according to said hot pack; and,
copying said plurality of dictums into said address space of said target software application.

30. The system of claim 26 including:
at least one grain associated with at least one of said first version grains having an active and inactive state; and,
said computer readable instructions include instructions for activating said crumb upon the determination that said status of said dictum associated with at least one of said first version grains does not allow for its immediate modification.

31. The system of claim 30 wherein said computer readable instructions include instructions for when encountering said crumb in an active state:
suspending said executing software application;
determining whether any of said plurality of dictums previously unexecuted can be executed,
modifying said first version grains according to said second version grains and said associated dictum if said determination of whether said dictum can be executed is affirmative, and,
resuming execution of said target software application so that said target application can be modified without halting its execution.

32. A computerized system embodied in a computer readable medium for modifying a target software application segmented into first version grains, comprising:
a set of computer readable instructions embodied in said computer readable medium for:
receiving a hot pack having a dictum and a second version grain associated with at least one of said first version grains,
suspending said target software application,
modifying at least one of said first version grains of said target software application according to said second version grain and said dictum of said hot pack, and,
resuming execution of said target application so that modification of said target software application is achieved without halting its execution.

33. The system of claim 32 wherein said computer readable instructions include instructions for triggering performance of a validity operation according to said dictum so that data and functional integrity is maintained within said target software application subsequent modification of said target software application.

34. The system of claim 32 wherein said computer readable instructions include instructions for copying said second version grain into said computer readable medium.

35. The system of claim 32 wherein said computer readable instructions include instructions for copying said dictum into said computer readable medium.

36. The system of claim 32 including:
at least one crumb associated with at least one of said first version grains having an active and inactive state; and,
said computer readable instructions include instructions for activating said associated crumbs upon the determination that said dictum associated with said first version grain does not allow for its execution at a predetermined time.

37. The system of claim 36 wherein said computer readable instructions include instructions for, when encountering said crumb in an active state:
suspending said executing software application;
determining whether said dictum associated with said active crumb can be executed;
modifying said first version grain according to said second version grain and said dictum if said determination of whether said dictum can be executed is affirmative, and,
resuming execution of said target software application so that said target application is modified without halting its execution.

38. The system of claim 37 wherein said computer readable instructions include instruction for adding at least one crumb to at least one of said first version grains that are to be modified according to said hot pack.
